(19) United States
(12) Patent Application Publication
(10) Pub. No.: US 2005/0043010 A1
(43) Pub. Date: Feb. 24, 2005

(54) Call accounting for wireless handheld device

(76) Inventor: Ron Rosansky, New York, NY (US)

Correspondence Address: Michael B. Johannesen, Esq.;Lowenstein Sandler, P.C., 65 Livingston Avenue, Roseland, NY, 07068, US

(21) Appl. No.: 10/643,511

(22) Filed: Aug. 19, 2003

(51) Int. Cl. H04M 11/00

(52) U.S. Cl. 455/405; 455/406; 455/550.1

(57) ABSTRACT

A system and method for use with a wireless handheld device wherein a database at an enterprise server captures airtime usage and related client matter information of the wireless handheld device. The wireless handheld device is configured for wireless communication and for automatically transmitting client and matter information and wireless communication usage to the database system. The database system then relates the wireless communication usage and professional services time associated therewith to one of the matters. In this manner, communication costs and professional services associated with the wireless handheld device may be recovered.

### FIELD OF THE INVENTION

This invention relates to the field of wireless communications, and, more specifically, to a system and method for creating and capturing wireless communications usage information and time accounting information from a wireless handheld device for use in a client billing system.

### BACKGROUND OF THE INVENTION

Most business enterprises have some form of accounting cost controls on telephone calls. For example, some businesses block long-distance calls, calls to certain numbers, etc. Many businesses, such as law firms, accounting firms and the like, keep track of all calls in order to pass business-related charges back to the client.

To this end, telephone switching equipment manufacturers build call accounting systems into PBX's and other line-based equipment. In general, the user must enter a billing code (e.g., client code and matter number) in association with every call. Some systems require this information to be entered before a call can be completed. An accounting system records the client information and relates it to the calling and called telephone numbers and the duration of the call to generate a call record. It saves the call record information and bills the client accordingly.

Today's technology, however, bypasses these hardwired accounting systems. Many enterprises are now using wireless technology, so that their employees can do business anytime, anywhere. For example, wireless handheld systems, such as the Blackberry system (see www.blackberry.com for a description of its technology), sends and receives voice calls, as well as email, wirelessly. Since it is in the enterprise's interest to have its personnel “in touch” with each other, and, more importantly, with clients, many business enterprises are standardizing on such systems.

These wireless handheld systems, however, do not have sophisticated accounting and billing mechanisms that are available to landline-based telephones. In the best case, call records can be matched to client by dialed telephone number and billed accordingly. In the worst case, a person has to comb through phone bills to correlate a particular call to a client and matter.

A further problem with enterprise wireless technology is that the user is frequently engaged in another matter when a call is made. This is especially true for incoming calls, but also applies to outgoing calls made while, for example, the user is traveling. Frequently, professional service time for the call is not recorded as billable time to the client because the user does not or cannot immediately record his or her time and forgets to do so later. Therefore, there is a problem in the art wherein wireless telephony charges, such as air time and long distance and professional services time, is difficult to correlate to a client and matter, if it can be correlated at all.

### SUMMARY OF THE INVENTION

This problem is solved and a technical advance is achieved in the art by a system and method that captures airtime usage of a wireless handheld device and can generate related call records. The system according to this invention comprises a database system that stores a plurality of matters and is configured to communicate with a wireless handheld device. This invention further comprises a wireless handheld device configured for wireless communication and for automatically transmitting call record information and related wireless communication usage to the database system. The database system relates the wireless communication usage to one of the matters based on the call record information. In this manner, communication costs associated with the wireless handheld devices may be recovered.

Additionally, the same timing information, client identification and matter number can be captured. Such time and billing information can then be formatted and entered into a time and billing system. In this manner, professional services time relating to communication with clients is automatically captured and billed.

According to an exemplary embodiment of this invention, a method for capturing airtime usage and professional services time in a wireless handheld device and attributing the airtime usage to one of a plurality of matters comprises detecting airtime usage, capturing matter information related to the airtime usage in a call record stored in memory of the wireless handheld device and transmitting the call record information from the wireless handheld device to a central database. The call record information is matched to a matter in the central database so that costs for the airtime usage are attributable to the matter. Additionally, the professional services associated with the airtime usage is also attributed to the matter. Advantageously, the wireless handheld device provides voice communication and the detection of airtime usage comprises automatic detection of incoming and outgoing calls and timing the duration thereof.

Further, the wireless handheld device may prompt a user for matter information either before or after airtime usage. In response to the prompt, the user enters an alphanumeric string that identifies the client matter number. The matter number, duration and, optionally, other information is transmitted via a data message over the wireless interface to the database system.

### BRIEF DESCRIPTION OF THE DRAWINGS

A more complete understanding of this invention may be obtained from a consideration of this specification taken in conjunction with the drawings, in which:

FIG. 1 is a block diagram of an overview of an exemplary embodiment of this invention;

FIG. 2 is a block diagram of a generic wireless handheld device as shown in FIG. 1;

FIGS. 3-7 are screen shots of operational screens for capturing information in the wireless handheld device of FIG. 2;

FIG. 8 is a functional block diagram of the operational software in the wireless handheld device of FIG. 2;

FIGS. 9-11 are flowcharts of operation according to the functional block diagram of FIG. 8 in the wireless handheld device of FIG. 2;

FIG. 12 is a flowchart of operations for capturing call information at the application server of FIG. 1; and

FIG. 13 is a screenshot of an application server as shown in FIG. 1.

### DETAILED DESCRIPTION

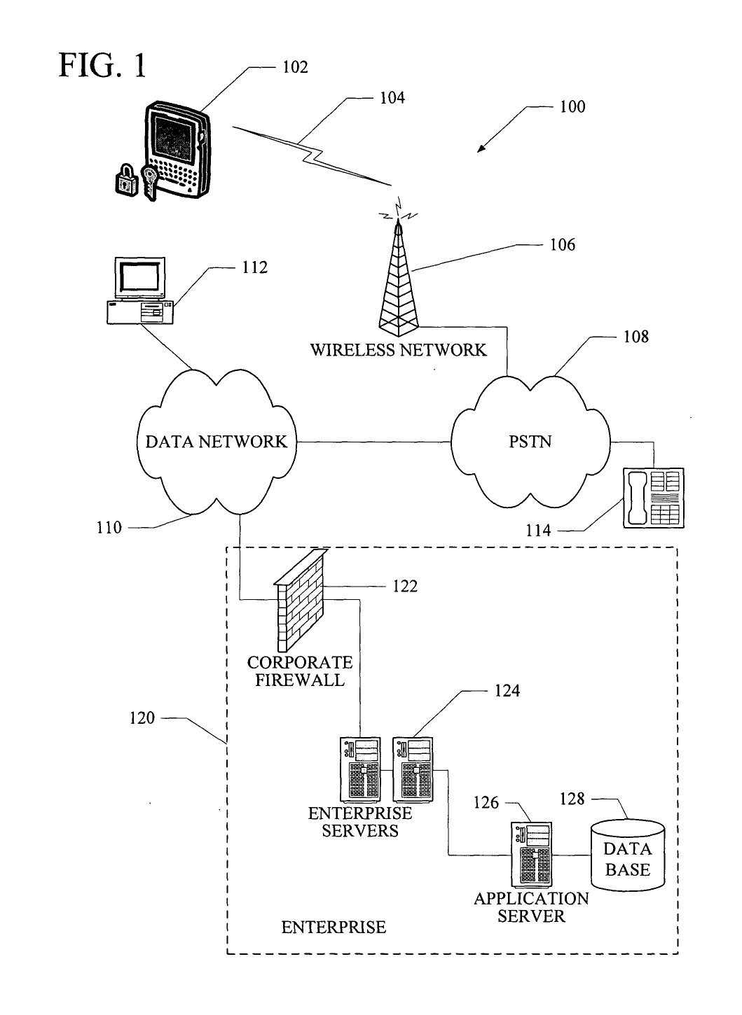

Turning now to FIG. 1, an exemplary embodiment of this invention is shown in the context of a communications network 100. A wireless handheld device 102 is illustrated as being in wireless communication 104 with wireless network 106. Wireless handheld device 102 is, in this exemplary embodiment, a Blackberry wireless handheld communication device, as is known in the art and described at www.blackberry.com, which is incorporated herein by reference. While this exemplary embodiment is described in terms of a Blackberry wireless handheld device, any wireless handheld device that provides wireless communication can be used in the context of this invention by one skilled in the art after studying this specification.

For purposes of describing this invention, wireless network 106 is connected to the public switched telephone network (PSTN) 108. Also connected to PSTN 108 is telephone 114. It is known in the art that a wireless handheld device 102 with an integrated telephone may make and receive telephone calls via wireless network 106 and PSTN 108 to and from telephone 114. While this invention is illustrated in terms of calls to and from a land line telephone 114, one skilled in the art will realize that, once a call is in wireless network 106, PSTN 108 or both, the call may originate or terminate virtually anywhere in the world, on land line or wireless equipment.

Further, a data network 110 is connected to PSTN 108, which, in this exemplary embodiment, comprises the Internet. A personal computer (PC) 112 is shown here connected to data network 110. It is known in the art that wireless handheld device 102 may make and receive email via data network 110, PSTN 108 and wireless network 106. While this invention is described in terms of communicating over the Internet, one skilled in the art will realize that any data network, public or private, may be used after studying this specification. Also, while this invention is described in terms of sending and receiving email from PC 112, one skilled in the art will realize that email communication may be with any device that can communicate over data network 110.

According to this exemplary embodiment of this invention, whenever a telephone call is completed between wireless device 102 and a destination device, such as telephone 114, a call record is created in wireless handheld device 102. In this call record, the elapsed time of the call is recorded and, optionally, the called telephone number. The user of wireless handheld device 102 is prompted to enter a client identification number and a matter identification number, which is also put in the call record. The call record is then stored in memory of wireless handheld device 102.

According to another aspect of this exemplary embodiment of this invention, whenever email is sent between wireless device 102 and a destination device, such as PC 112, a call record is created in wireless handheld device 102. In this call record, the elapsed time of the data transmission is recorded. The user of wireless handheld device 102 is prompted to enter a client identification number and a matter identification number, which is also put in the call record. The call record is then stored in memory of wireless handheld device 102.

Further in accordance with this exemplary embodiment of this invention, wireless handheld device 102 transmits the collected call records to an accounting system for billing purposes. To this end, wireless handheld device 102 formats a data record containing the call record information and transmits it over air interface 104 to wireless network 106. The message may be in the form of short message service, an email message or any other form of data transmission. Wireless network 106 forwards the message through PSTN 108 to data network 110 which routes it to an enterprise 120.

A corporate firewall 122 is connected to data network 110 in order to maintain security within enterprise 120, as is known in the art. Firewall 122 screens the data message from wireless handheld device 102 and forwards it to an enterprise server system 124. Enterprise server system 124 comprises one or more servers that communicate with wireless handheld devices, such as 102, for the entire enterprise 120. For more information regarding an exemplary system, see the above-referenced Blackberry web site.

According to an exemplary embodiment of this invention, enterprise server 124 forwards the call record message to application server 126. Application server 126 parses the message and stores the relevant call record information in database 128. Information regarding calls made through wireless handheld device 102 is now stored in database 128. Stored information may then be automatically sorted and used as input into a billing system. Call data, such as airtime usage and long distance charges, can then be billed back to a client. Further, professional service time can also be billed to the client associated with the client ID that the user of wireless handheld device 102 entered, because the same information applies to telephone cost recovery and professional services time and billing.

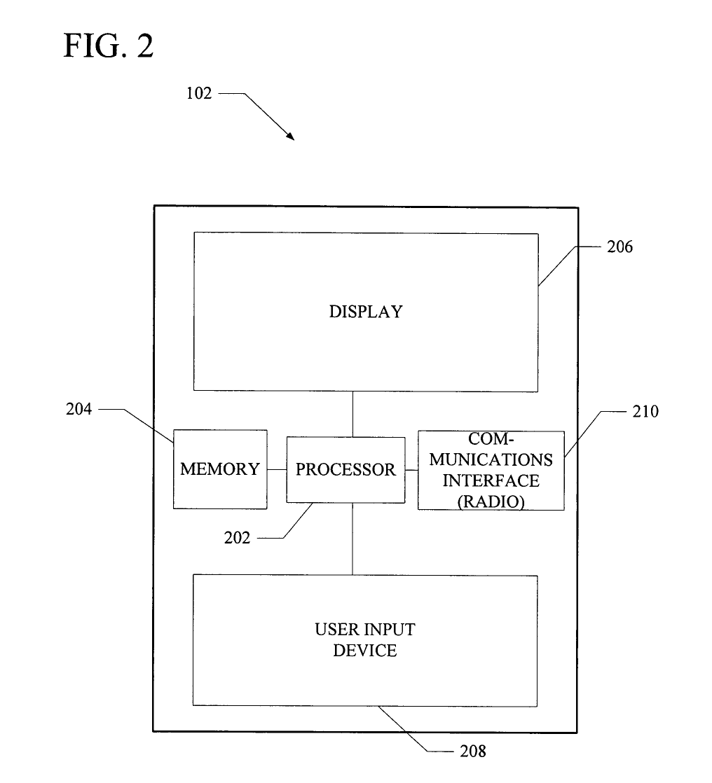

Turning now to FIG. 2, a block diagram of the relevant components of wireless handheld device 102 is shown. At the heart of wireless handheld device 102 is processor 202. Processor 202 runs programs and controls other components of the system as is known in the art. Processor 202 uses programs and data stored in memory 204 in order to perform its functions.

Processor 202 causes display 206 to display information to the user. Processor 202 accepts input from one or more user input devices, represented by user input device 208. User input device 208 may be a keyboard, a stylus pad, etc., or a combination of these devices. Processor 202 also controls communications interface (radio) 210 to effect communication with wireless network 106. While this exemplary embodiment of this invention is described in terms of a generic wireless handheld device 102, one skilled in the art will appreciate how to implement this invention in specific wireless handheld devices after studying the specification.

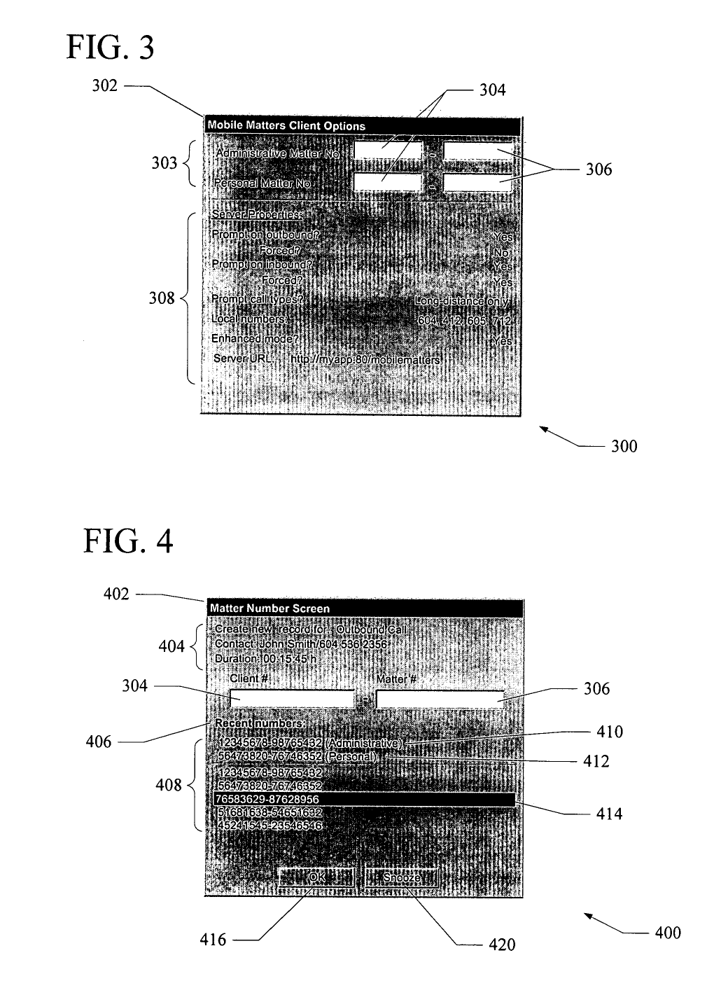

Turning now to FIG. 3, an exemplary display screen 300 for setting options in accordance with an exemplary embodiment of this invention is shown. Display screen 300 pops up on display 206 (FIG. 2) when, for example, wireless handheld device 102 is first turned on or when the user selects screen 300 to set or reset options.

Display screen 300 includes title bar 302, which identifies the applications (“Mobile Matters Client”) and the screen title (“options”). At 303, the user is prompted to enter client numbers 304 and matter numbers 306 for “administrative matters” and “personal matters,” respectively. Administrative matters and personal matters are two frequently-used numbers, which can then be selected rather than entered every time one is needed, as will be illustrated further, below.

At 308, the user is prompted to enter defaults for a plurality of operational parameters. These parameters are used in the operation of wireless handheld device 102, as will be discussed further, below. Alternatively, screen 300 may be reserved for a system administrator to set and then locked so that the user cannot change these settings.

Turning now to FIG. 4, an exemplary pop up screen 400 for entering client number 304 and matter number 306 in relation to a call is shown. Display screen 400 pops up, for example, when an outgoing call has been detected. Display screen 400 is specifically for use after a voice call is complete. In an alternative embodiment, a screen similar to Display screen 400 may pop up when a call is started. Further, a similar screen may pop up when a user opens an email application for reading or writing.

A screen title and name is shown at 302 (“Matter Number Screen”). The type of call (“outbound” in this example), the contact and the duration of the call are shown at 404. The user enters a client number in box 304 and a matter number in box 306 using input device 208 (FIG. 2). Recently entered numbers 406 are shown in a list 408 comprises a plurality of entries. In this exemplary embodiment, there are an administrative number 410 and personal use number 412 previously entered into wireless handheld device 102 (in accordance with FIG. 3, above). Several recently used entries are illustrated at 408. If the current contact 404 is in the list of recently used numbers 408, it may be highlighted, as shown at 414. Optionally, there may be a description of the client number and matter number.

When the user is finished entering the information, the user pushes the “OK” button 416. If the user does not wish to enter the client number and matter number at this time (or cannot because he or she is driving, for example), the user can select the “Snooze” button 420. As will be discussed further, below, snooze button 420 causes this call record to be stored for later entry of client number and matter number.

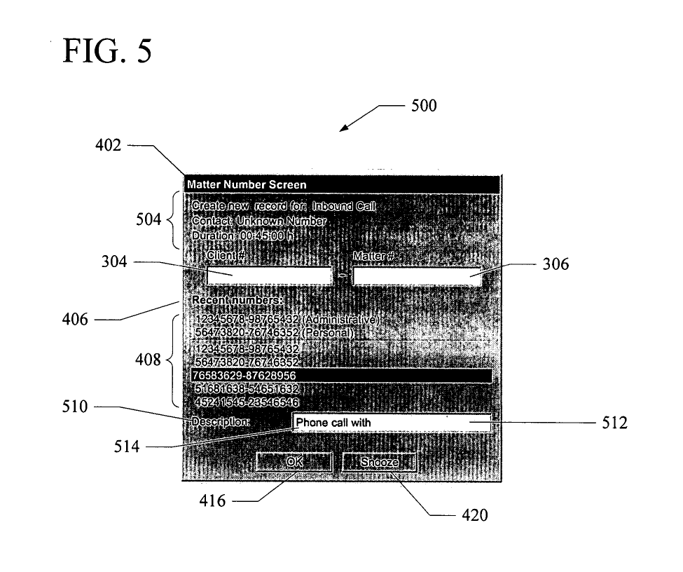

Turning now to FIG. 5, a further exemplary display screen 500 for entering client number 304 and matter number 306 is shown. Display screen 500 includes title bar 402, call information 504 (in the example of FIG. 5 call information 504 indicates an “inbound” call), recently entered numbers label 406 and list 408, OK button 416 and snooze button 420. Further, pop up screen 500 also includes a prompt 510 for the user to enter a description of the matter or subject of the call. The user enters the description in box 512. In this exemplary embodiment, the description is partially filled at 514 because wireless handheld device 102 knows that the user is responding to an incoming call.

In accordance with another aspect of this invention, a description may be dictated into the wireless handheld device 102 and recorded as, for example, a .wav file. The .wav file is then appended to the data message transmitted to server 136. The .wav file may then be transcribed by an attendant or via speech recognition.

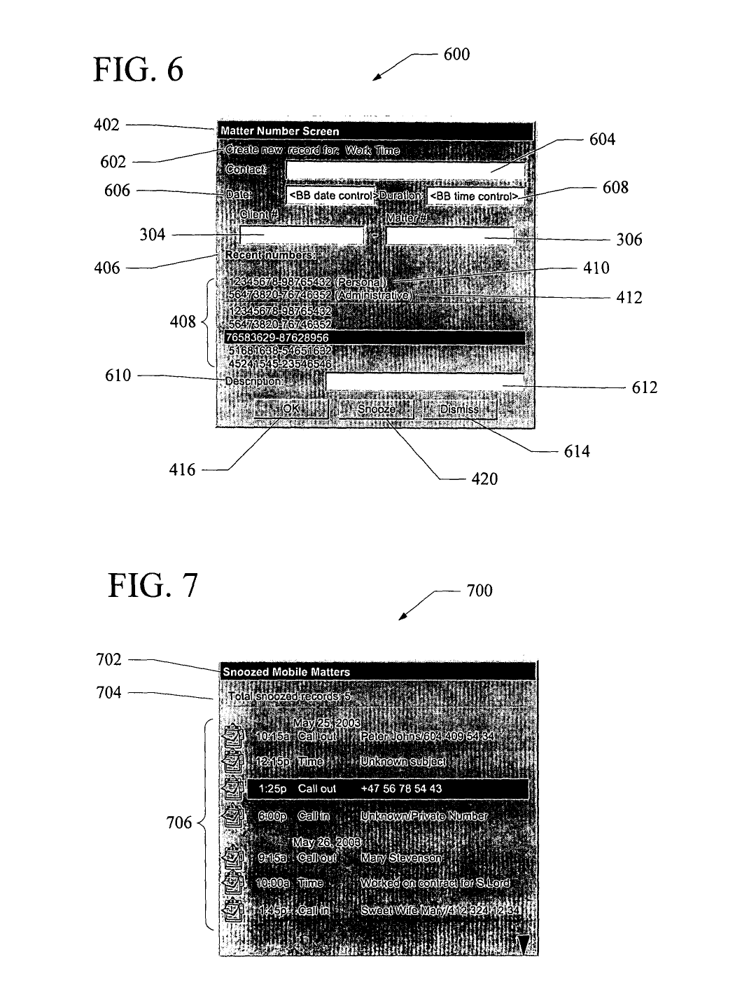

Turning now to FIG. 6, an exemplary pop up display screen 600 according to another aspect of this invention is shown. Pop up display screen 600 is for professional services time and billing entry. Display screen 600 includes title bar 402 and screen title 602. The user may enter contact information in box 604 (which would correspond to a contact in, for example, a contact address book as is known in the art).

The user may enter a date at 606 or, optionally, use a date automatically provided by wireless handheld device 102 date controls. The user may enter a time duration at 608, or optionally, use a duration automatically provided by wireless handheld device 102 time controls.

The user may enter a client number 304 and matter number 306, or select one from the recent numbers 406 list 408. In addition, the user is prompted at 610 to enter a description at 612. The user then selects OK 322, snooze 324 or dismiss 614 (to cancel).

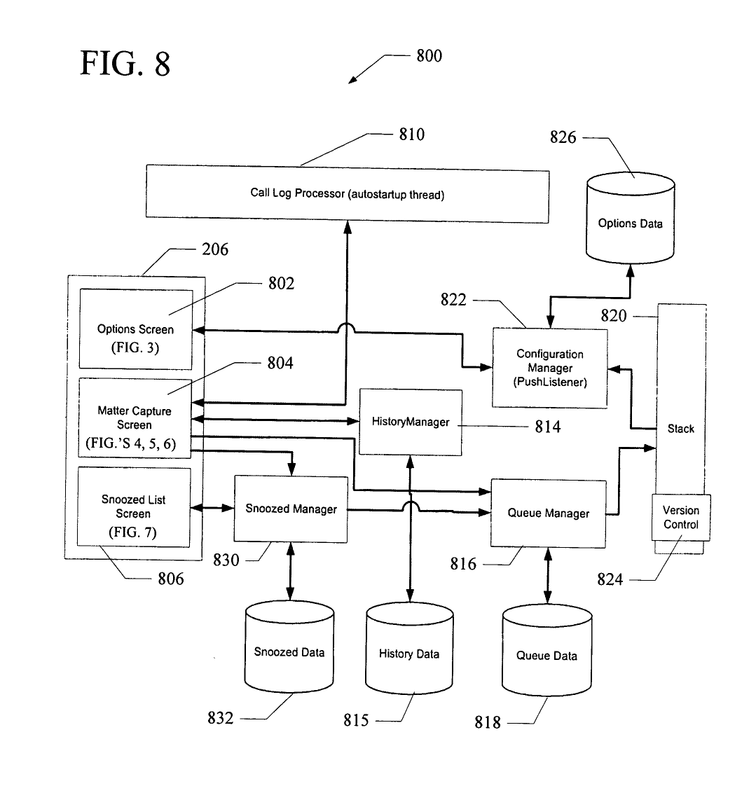

Turning now to FIG. 7, a further pop up screen according to another aspect of this invention is shown. Screen 700 illustrates a pop up screen for snoozed matters, which were not completely recorded. Screen shot 700 includes heading 702 and a total number of incomplete records 704. A list 706 of incomplete records is shown, along with whatever information is available. In screen shot 700, some “snoozed” records illustrated in list 706 include incoming calls, some are outgoing calls and some are professional service time records. In accordance with another aspect of this invention, snoozed records may also be available to the user at his or her PC (or laptop). These records may then be filled in at the user's convenience.

Turning now to FIG. 8, a process control block diagram according to an exemplary embodiment of this invention is shown. Display 206 shows the user various screens, as illustrated in FIGS. 3-7, above. For purposes of FIG. 8, there are three screens: options (configuration) screen 802 (FIG. 2), matter capture screen 804 (FIGS. 4-6) and snoozed list screen 806 (FIG. 7).

A call log processor 810 is automatically started upon external events (e.g., an incoming call, an outgoing call, opening an email application, etc.). Call log processor 810 communicates with matter capture screen 804 to receive input from the user. Matter capture screen 804 also cooperates with history manager 814. History manager contains access functions and save methods for history database 815.

Queue manager 816 also communicates with matter capture screen 804. Queue manger 816 manages information queue data 818 and queue delivery via stack 820. Stack 820 receives low level push notifications, reads them and sends data to configuration manager 822. Stack 820 also contains functions to send data to the server 126 (FIG. 1). Version control 824 checks versions of all server-received messages before they are delivered further. Version control 824 does not deliver those messages that conflict with the version of the software within wireless handheld device 102.

Configuration manager 822 communicates with options screen 802 and contains functions to check options, encapsulates options logic and saves and read data from options database 826. Finally, snoozed manager 830 cooperates with snoozed list screen 806 to interface to snoozed item in snoozed data 832. Snoozed manager 830 also communicates completed items to queue manager 816.

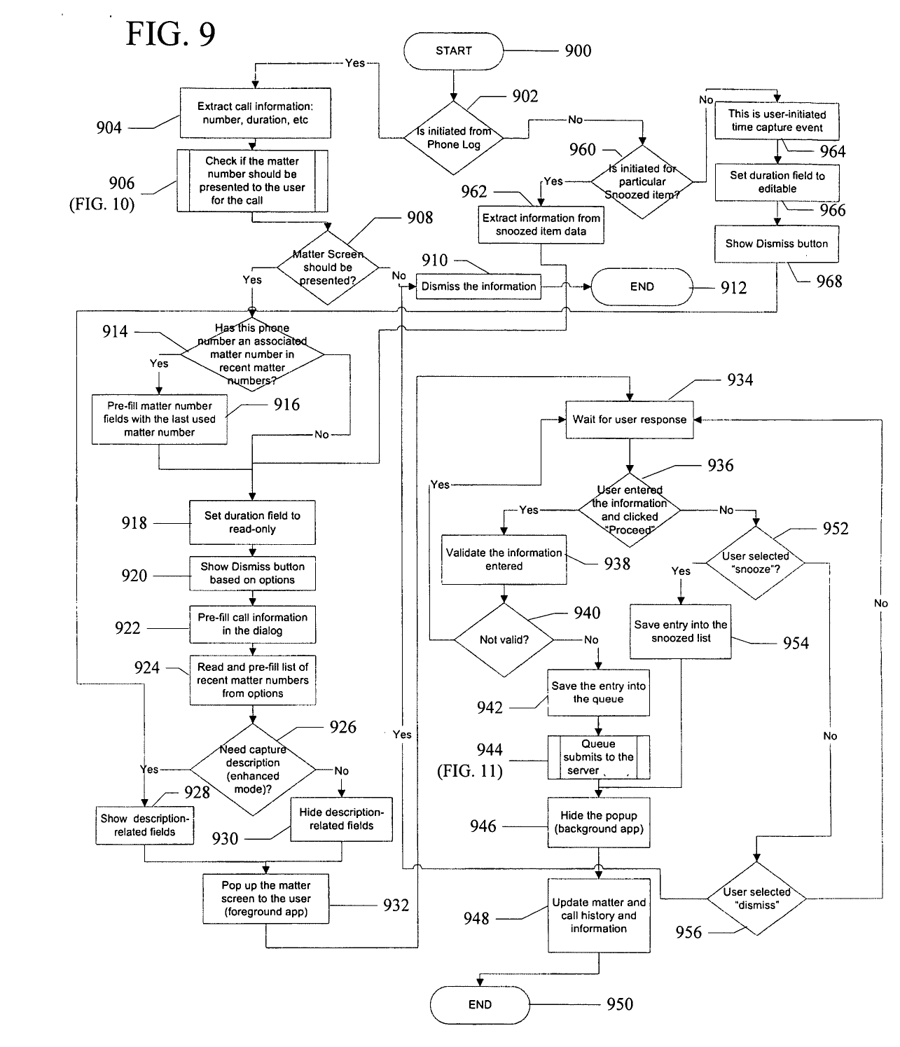

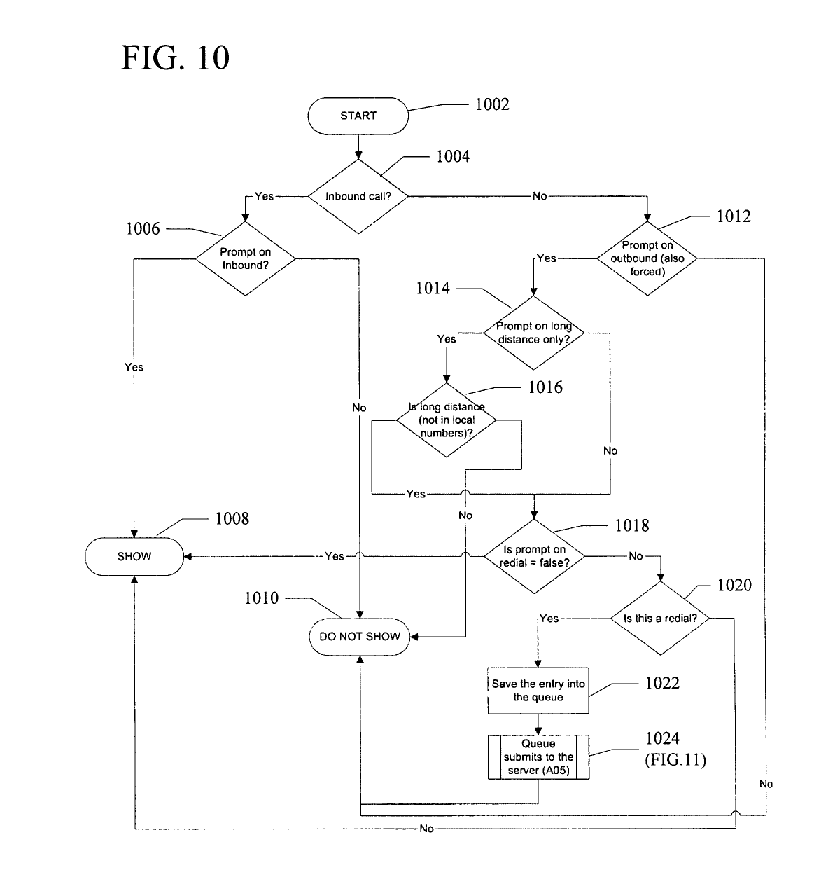

Turning now to FIG. 9, a flow chart of processing to effect an exemplary embodiment of this invention in wireless handheld device 102 and in accordance with the modules of FIG. 8 is illustrated. Processing starts at oval 900 and proceeds to decision diamond 902, where a determination is made whether the process is initiated from the phone log or not. If it is, then processing moves to box 904 where the call information is extracted. Processing proceeds to procedure call 906, which is described in connection with FIG. 10. While this flowchart is described in terms of phone calls, the start of other functionality of wireless handheld device 102, such as opening an email application may also trigger this leg of code.

Processing continues to decision diamond 908, where a decision is made whether the matter screen should be presented. If not, then processing moves to action box 910 where the information is dismissed, and processing ends in oval 912.

If, in decision diamond 908, the matter screen should be presented, then processing moves to decision diamond 914. In decision diamond 914, a determination is made whether the phone number has an associated matter number in recent matter numbers. If so, then, in action box 916, the matter number fields are pre-filled with the last used matter number. Processing from the “no” branch of decision diamond 914 and from box 916 moves to box 918, where the duration field is set to “read only.” Optionally, in box 920, the “Dismiss” button may be displayed, based on options set on options screen, FIG. 3.

Processing moves to action box 922, where the call information is pre-filled in the dialog box. In action box 924, the recent list of matter numbers is pre-filled. Processing proceeds to decision diamond 926, where a decision is made whether a description needs to be captured (e.g., for professional services records). If so, description related fields are displayed in box 928, if not description related fields are hidden in action box 930. Processing moves from both action box 928 and action box 930 to action box 932, where a matter screen (selected from FIGS. 4-6) is displayed to the user.

Processing proceeds to action box 934, where the system waits for a user response. Processing moves to decision diamond 936, where a determination is made whether the user entered information and selected “OK.” If the user selected “OK,” then the information entered is validated in box 938. If, in decision diamond 940, the information entered is not valid, then processing proceeds back to box 934, where processing waits for the user to enter information.

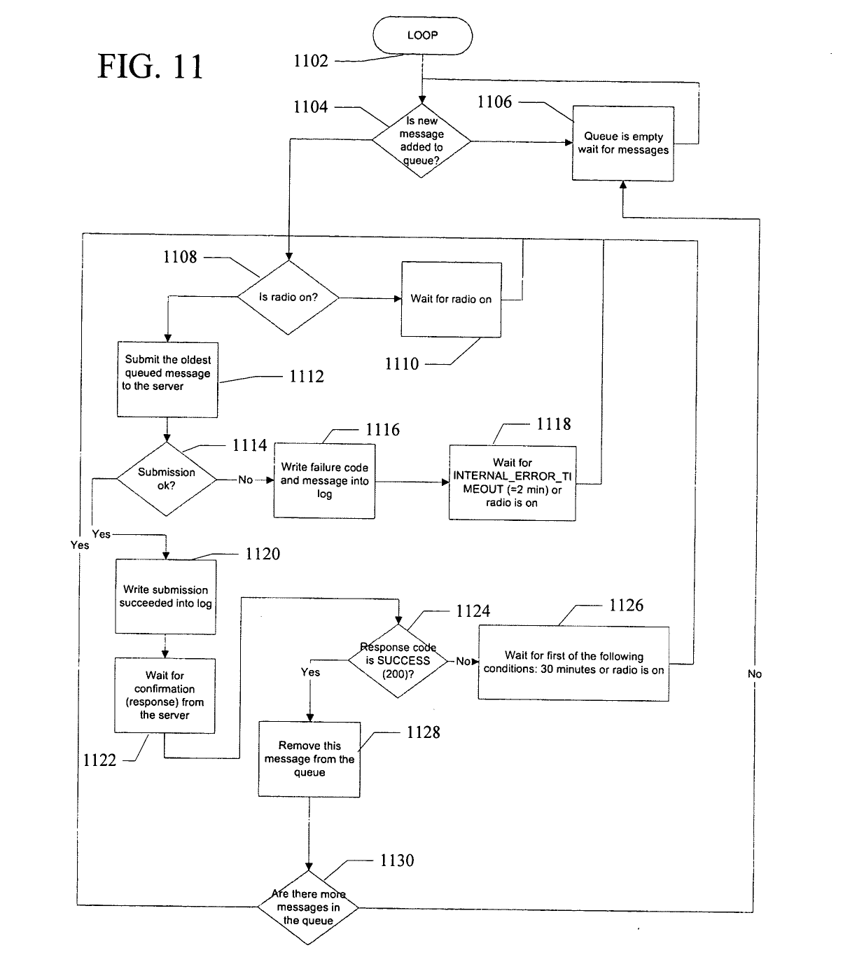

If, in decision diamond 940, the information is valid, then processing move to box 942 where the entry is sent to the queue manager 716 (FIG. 7). In box 944, a procedure call is made to processing as described in FIG. 11. When processing returns from box 942, the screen is hidden in box 946. The matter and call history information is updated in box 948. Processing ends in oval 950.

If, in decision diamond 936, the user did not select enter, then processing moves to decision diamond 952, where a decision is made whether the user selected “snooze.” If the user selected “snooze,” then processing proceeds to action box 954 where the entry is sent to the snooze manager 730 (FIG. 7). Processing then continues with steps 946, 948 and finally 950, as described above. If the user did not select “snooze” in decision diamond 952, then processing proceeds to decision diamond 956 to determine whether the user selected “dismiss.” If the user did not select “dismiss,” then processing moves to box 934. If the user did select dismiss, then processing proceeds to box 910 and ends in oval 912.

Returning now to decision diamond 902, if the call is not initiated from the phone log, then processing proceeds to decision diamond 960. In decision diamond 960, a determination is made whether the user is editing a snoozed record. If the user is editing a snoozed record, then processing proceeds to box 962, where the stored information for the snoozed data item is retrieved. Processing continues with box 918, et seq., as described above.

If, in decision diamond 960, the entry is not for a snoozed item, then processing moves to box 964, where a time capture is performed. In box 966, the duration field is set to editable and, in box 968, the dismiss button is shown to the user. Processing continues with box 928, et seq., as described above.

Turing now to FIG. 10, a flowchart 1000 is shown that describes processing for determining whether the matter number should be presented to the user, box 906, FIG. 9. Processing starts in oval 1002 and moves to decision diamond 1004. In decision diamond 1004, a determination is made whether the current call is an incoming call. If it is, then the configuration manager is consulted and, in decision diamond 1006, a determination is made whether the user is prompted on an inbound call. If the user is prompted on inbound calls, then the user is prompted in oval 1008, where processing ends.

If, in decision diamond 1006, the user is not prompted on inbound calls (according to the configuration manager), then processing ends in oval 1010, where the input screen is not shown. If, in decision diamond 1004, the call is not an inbound call, then processing moves to decision diamond 1012, where a determination is made whether the user is prompted on outbound calls. This may also be forced, based on the options and the configuration manager. If prompting of outbound calls is not forced, processing ends in oval 1010.

If, in decision diamond 1012, the user is to be prompted on outbound calls, then processing proceeds to decision diamond 1014, where a determination is made whether the user is prompted to enter a client number and user number on long distance calls only. If so, processing moves to decision diamond 1016, where a determination is made whether this is a long-distance call. If it is not a long distance call, then processing ends in oval 1010.

If, in decision diamond 1012, a determination is made that the call is a long distance call, then processing moves to decision diamond 1018, where a determination is made whether prompt on redial is off. If prompt on redial is on, then processing ends at oval 1008, where the input screen is shown. If prompt on redial is off, then a determination is made in decision diamond 1020 whether this call is a redialed call. If it is not a redialed call, then processing ends at oval 1008, where the input screen is shown.

If, in decision diamond 1020, a determination is made that this call is redialed, then the previously-entered client and matter entry is saved to the queue in box 1022. In box 1024, the queue manager submits the entry to the server in accordance with processing shown in connection with FIG. 11, below. Processing then ends in oval 1010, and thus the prompt screen is not shown to the user.

Turning now to FIG. 11, a flowchart for processing within queue manager 716 referenced in box 944, FIG. 9 and box 1024, FIG. 10. Processing starts at oval 1102, which is the being of a loop, as is known in the art. Processing moves to decision diamond 1104 where a determination is made whether there is a new message in the queue to be sent to application server 126 (FIG. 1). If there is not, then processing moves to box 1106 where the queue is empty and waiting for messages. Processing loops back to decision diamond 1104.

If, in decision diamond 1108, there is a message in the queue, then processing moves to decision diamond 1108 where a determination is made whether the radio (communications interface 210, FIG. 2) is on. If it is not, then processing waits for radio on in box 1109 and loops back to decision diamond 1108.

If the radio is on in decision diamond 1108, then processing proceeds to box 1110 where the oldest message in the queue is submitted to server 126 (FIG. 1). Processing continues to decision diamond 1114 where a determination is made whether the submission was successful. If it was not, then processing moves to box 1116 where a failure code and the message are written into a log. Processing continues to box 1118, where the error is timed for retry or for the radio to be turned on. Processing loops back to decision diamond 1108.

If the submission succeeded in decision diamond 1114, then processing proceeds to box 1120 where a submission success is written into the log. Processing continues to box 1122, where processing waits for an acknowledgement from the server. If, in decision diamond 1124 the response code is not “success,” then processing moves to box 1126 where processing waits for 30 minutes, the radio is turned on, or both, before looping back to decision diamond 1108.

If, in decision diamond 1124, the server code is “success,” then processing proceeds to box 1128, where the current message is removed from the queue. A determination is made in decision diamond 1130 where there are any further messages in the queue. If there are, then processing loops back to decision diamond 1108. If there are no further messages in the queue, then processing loops back to box 1106.

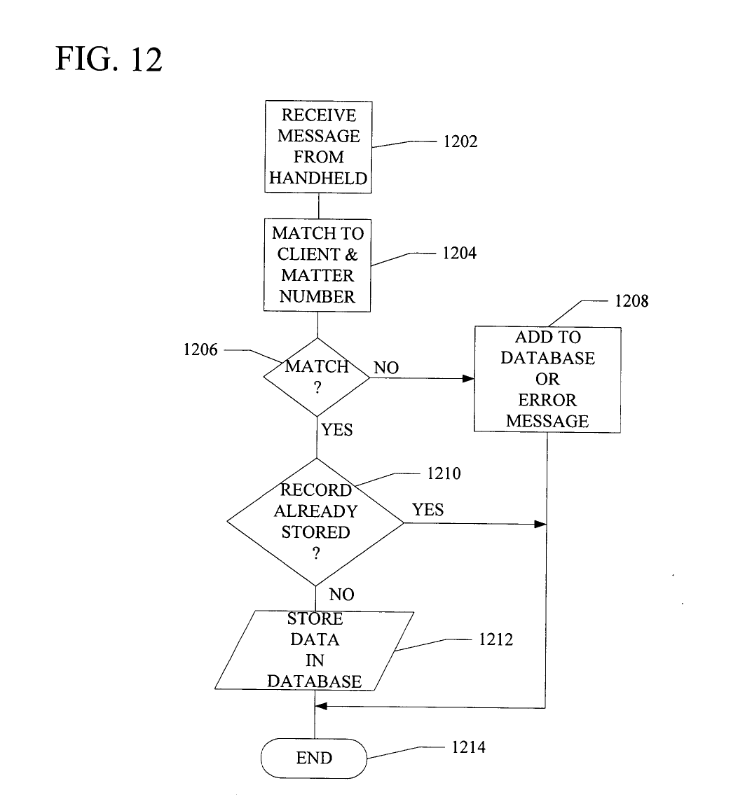

Turning now to FIG. 12, a flow chart illustrating processing at application server 126 and database 128 (FIG. 1) is shown. Processing starts at box 1202 where a message is received from a user's wireless handheld device 102. Application server 126 matches the recorded client number and matter number in action box 1204 to client numbers and matter numbers in database 128.

Processing proceeds to decision diamond 1206 where a determination is made if there is a match found with the client number and matter number. Optionally, in action box 1208, the client number and matter number may be added to the database or an error message may be generated. This error message may be sent back via data message, e-mail, short messaging service or other means to wireless handheld device 102, or saved for later use. Processing moves both from decision diamond 1206 and action box 1209 to user storage box 1210 where the information is stored in a database for later accumulation and billing to the client. Processing ends at 1212. Other functionality at server 126, such as configuring server 126, adding users, adding groups, etc. are well known in the art and therefore not further discussed.

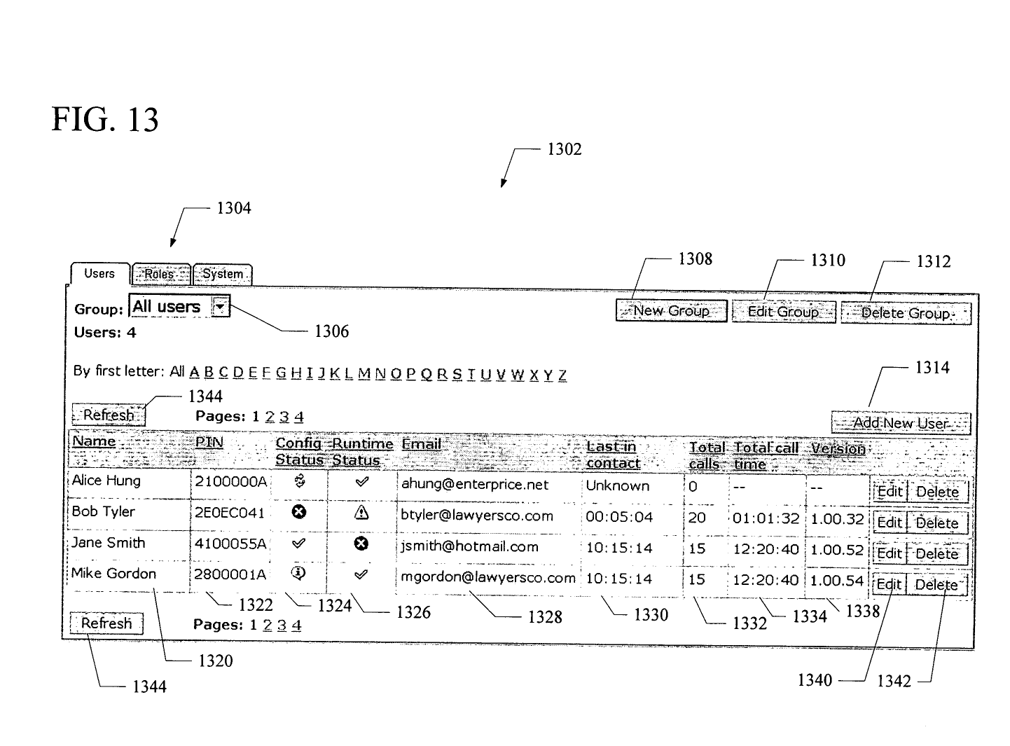

FIG. 13 illustrates a screen shot 1302 of application server 126. Screen shot 1302 illustrates an overall control screen of application server 126. The manager can select various view using tabs 1304. Groups of wireless handheld devices 102 are selectable at group drop-down menu 1306. The manager can add a new group at button 1308, edit a group at button 1310 and delete a group at button 1312. The server manager may add a new user at button 1314.

Screen Shot 1302 also lists information regarding each wireless handheld device in the system, including name 1320, PIN 1322, configuration status 1324, runtime status 1326 and email address 1328. Further, screen 1302 may include information such as last time in contact 1330, total number of calls 1332, total call time 1334 and the version of the software 1336. The information regarding each user may be edited by selecting a button 1340 or deleted by selecting a button 1342. The screen 1202 may be refreshed by selecting button 1344.

It is to be understood that the above-described embodiment is merely illustrative of the present invention and that many variations of the above-described embodiment can be devised by one skilled in the art without departing from the scope of the invention. It is therefore intended that such variations be included within the scope of the following claims and their equivalents.

1. A method for capturing airtime usage information in a wireless handheld device and attributing said airtime usage to one of a plurality of matters comprising:
detecting and timing airtime usage;
capturing call record information related to the airtime usage in memory of the wireless handheld device; and
transmitting captured call record information and airtime usage timing from said wireless handheld device to a database so that costs for said airtime usage are attributable to said matter.

2. A method in accordance with claim 1 wherein said wireless handheld device provides voice communication and wherein detecting airtime usage comprises detecting an outgoing call and timing said outgoing call.

3. A method in accordance with claim 1 wherein said wireless handheld device provides voice communication and wherein said detecting airtime usage comprises detecting an incoming call and timing said incoming call.

4. A method in accordance with claim 1 wherein capturing call record information comprises prompting a user for matter information prior to airtime usage.

5. A method in accordance with claim 1 wherein said capturing call record information comprises prompting a user for call record information after airtime usage.

6. A method in accordance with claim 1 wherein capturing call record information comprises a user entering an alphanumeric string that identifies the client matter number.

7. A method in accordance with claim 1 wherein capturing information comprises a user entering call record information verbally.

8. A method in accordance with claim 1 wherein capturing information comprises a user entering call record information manually.

9. A method in accordance with claim 1 wherein transmitting said call record information comprises sending a data message.

10. A method in accordance with claim 1 wherein captured call record information and airtime usage is used for generating personal services records.

11. A method in accordance with claim 1 wherein detecting airtime usage comprises detecting opening an email process.

12. A method in accordance with claim 1 wherein a plurality of call record information are stored in a list in said wireless handheld device and said user selects said client and matter information from said list.

13. A wireless handheld communication device comprising:
a timer configured to time wireless communication;
an input device to receive call record information from a user related to wireless communication;
storage configured to store call record information and timing information from said timer; and
a communications system to transmit said call record client and matter information and timing information to a central data processing system.

14. A wireless handheld communication device in accordance with claim 13 wherein said input device comprises means for prompting said user to enter call record information.

15. A wireless handheld communication device in accordance with claim 13 further including a voice communication system, wherein said timer is configured to time each call through said voice communication system and said input device is configured to receive call record information related to each call.

16. A wireless handheld communication device in accordance with claim 13 wherein said voice communication system is configured to make a call in response to said call record information being entered.

17. A wireless handheld communication device in accordance with claim 13 wherein said voice communication system is configured to prompt for said call record information in response to a call being received.

18. A system for capturing airtime usage of a wireless handheld device comprising:
a database system storing a plurality of clients and matters configured to communicate with said wireless handheld device and relate wireless communication usage to one of said clients and matters; and
a wireless handheld device configured for wireless communication and for automatically transmitting matter information and wireless communication usage to said database system.
